(19) United States
(12) Patent Application Publication
(10) Pub. No.: US 2019/0378389 A1
(43) Pub. Date: Dec. 12, 2019

(54) System and Method of Detecting a Potential Cashier Fraud

(71) Applicant: OOO ITV Group, Moscow (RU)

(72) Inventors: Murat K. Altuev, Moscow (RU); Alexey V. Govorovsky, Rostov-on-Don (RU); Ivan Y. Kalugin, Balashikha, Moscow Region (RU)

(21) Appl. No.: 16/373,571

(22) Filed: Apr. 2, 2019

(30) Foreign Application Priority Data
Jun. 6, 2018 (RU) 2018120934

(51) Int. Cl. G08B 13/196

(52) U.S. Cl. CPC G08B 13/19673; G08B 13/19656; G08B 13/19697; G08B 13/19608

(57) ABSTRACT

The present group of inventions relates to the area of computer vision, in particular to the processing systems and methods for video data obtained from surveillance cameras located in the cashier's barcode scanning area, as well as to the area of automatic detection of possible cashier fraud. A fraud-detecting computer-based system includes a barcode scanner; image capture device configured to receive video data from the cashier barcode scanning area; memory configured to store the data; a data processing module configured to receive and to process the video data signals from an image capture device and to receive and process the signals from the barcode scanner. During the video data processing, a data processing module detects the timing of placing an item against the barcode scanner and automatically compares it with the timing of receiving a signal from the barcode scanner. If no correlation is found between these events, then the data processing module detects a fraud by the cashier. The accuracy of detecting the cashier fraud is improved.

### RELATED APPLICATIONS

This application claims priority to Russian Patent Application No. RU 2018120934, filed Jun. 6, 2018, which is incorporated herein by reference in its entirety.

### FIELD OF THE INVENTION

The present group of inventions relates to the area of computer vision, in particular to the processing systems and methods for video data obtained from surveillance cameras located in cashier barcode scanning area, as well as to the field of automatic identification of possible cashier fraud.

### BACKGROUND

Point of sale systems are software and hardware solutions for selling merchandise and services in both cash and cashless modes. The merchandise must be recorded, and this information must be recorded in a store system and displayed on the receipt, while the store (point of sale, POS) must receive the sum of money shown in the receipt.

However, very often transaction processing at the checkout leads to a number of fraud schemes both by the customers and cashiers. For example, a cashier could deliberately or unintentionally transfer an item into the pickup area without registering it by barcode scanning, or a cashier could obstruct the barcode when placing the item against the barcode scanner, so that the merchandise is not registered. To do this, a cashier could collude with a customer.

The technical measures against this fraud at the checkouts are based on analysis algorithms for the POS transactions, as well as on surveillance systems data.

Surveillance systems are software and hardware systems using computer vision for automatic data collection based on analysis of streaming video (video analysis). Surveillance systems use image processing and image (objects) recognition algorithms to analyze the video with no direct user participation.

A typical video surveillance of a cashier prevents some problems and fraud. The results of video surveillance at the checkout include:

psychological effect—a video camera pointed at the cashier significantly affects the behavior of the cashier and the customer; and

facilitating an objective investigation—everything which occurring at the checkout, cashier's and customer's actions, merchandise scanning, inspection, and packaging, and payment, are recorded by a video camera.

Video surveillance is a suitable option for investigating incidents at the checkout and for responding to customers complaints, but it is very time-consuming and inefficient due to low accuracy of the cashiers' actions analysis and of analyzing the reasons of a large number of suspicious transitions at a POS terminal by just looking through all actions recorded at the checkout. Hence, to prevent theft and to detect fraud, one should have more advanced systems automatically processing the video data from the surveillance cameras and matching the data with the signal coming from the POS terminals.

One solution is disclosed in the US Application Publication US 2007/0058040 A1, published Mar. 15, 2007, which describes a surveillance method and system with a video camera, POS terminal, and a device receiving and analyzing signals from the camera and from the POS terminal to identify violations at POS. The main disadvantage of this solution is that the violations are identified by analyzing the cashiers' movements, in particular, by analyzing at least two types of cashiers' movements. This method is inaccurate and is likely to produce an error, since the cashiers' movements may be related both to placing the merchandise against the barcode scanner and with giving the money or with other moves not related to the transactions.

The solution disclosed in the Russian patent RU 2323475 C2, published Apr. 27, 2008, is the closest to the present in its technical features. This patent describes a method of automatic identification of deviation in the proper performance of a technological process, the method uses video data, the signal of finishing the technological process, and involves the following actions: identification of the typical sequence and movement routes of operating elements of a machine and/or operator's hands and/or a device for the right execution of a technological operation, organization of the collection of video data about the actions of a machine and/or operator dealing with this technological operation, indication of at least one detected area of the presence and/or movements of the operating elements of a machine and/or operator's hands, identified typical sequences and movement routes of the operating elements of a machine and/or operator's hands and/or a device during the technological operation, description of at least one scenario with the sequence and time correlations of the movements of the operating elements of a machine and/or operator's hands and/or a device in at least one control area of movements and/or occurrences of the sight of operating elements of a machine and/or operator's hands and/or a device in at least one area of presence; observation involves the following actions: color and/or brightness and time analyses of the observation area's images check for the movements of the operating elements of a machine and/or operator's hands in at least one movement control area, color and/or brightness and time analyses of the observation area's images check for the presence of the operating elements of a machine and/or operator's hands in at least one presence control area, the sequence of the detected events and time correlations between them are checked for the compliance with the scenarios, if this is the case for at least one scenario, the signal of finishing the technological operation is checked in accordance with this scenario, if there is no signal of finishing the technological operation, the execution of this operation is classified as wrong. This solution is taken to be a prototype.

The disadvantage of this solution is that the analysis of the video data identifies the movement routes of hands or devices. This method could hardly be reliable as the recognition system can have low accuracy due to detection of the movements not connected with the transactions. Besides, this method is characterized by high computational complexity due to preliminary stages for detecting the typical sequence and movement routes.

### BRIEF SUMMARY

The claimed technical solution is aimed at overcoming the disadvantages typical for the prior state of art and to improve the known solutions.

The technical result of the claimed group of inventions is an increase in the accuracy of detecting the cashier fraud.

This technical result is achieved by the fact that cashier fraud detecting computer-based system includes a barcode scanner; image capture device configured to receive the video data from the cashier barcode scanning area; memory configured to store the data; at least one data processing module configured to obtain and to process the signals from the barcode scanner, while during the video data processing at least one data processing module detects at least one event of placing an item against the barcode scanner and automatically compares the events of receiving a signal from the barcode scanner and the detected events of placing an item against the barcode scanner by time, and if no correlation is found between these events, then at least one data processing module detects cashier fraud.

According to one further embodiment of the invention, the video data from the image capture device and the signals from the barcode scanner are processed on a real time basis.

According to another further embodiment of the invention, the video data from the image capture device and the signals from the barcode scanner are processed in the archive data stored in the memory.

According to another further embodiment of the invention, once cashier fraud is detected, a notification to a user of a computer system is sent.

According to another further embodiment of the invention, the barcode is QR-code.

The specified technical result is also achieved by applying the method of detecting cashier fraud by a computer system consisting of at least one data processing module, and the method presupposes the stages when the signals from the barcode scanners are received and processed; the video data from the image capture device configured to receive the video data from the cashier barcode scanning area are received and processed; and during the video data processing at least one data processing module detects at least one event of placing an item against the barcode scanner and automatically compares the events of receiving the signal from the barcode scanner and the detected events of placing an item against the barcode scanner by time parameters, and if no correlation is found between these events, then at least one data processing module detects cashier fraud.

This technical result is also achieved by a computer-read data medium with CPU-executed instructions to embody the methods of detecting cashier fraud.

### BRIEF DESCRIPTION OF THE SEVERAL VIEWS OF THE DRAWINGS

FIG. 1 is a diagram of a computer system for detecting cashier fraud.

FIG. 2 is a flow chart of a fraud detection method.

### DETAILED DESCRIPTION

Possible embodiments for the claimed group of inventions are described below. However, the claimed group of inventions is not limited to these embodiments. It is apparent to those skilled in the art that the claimed group of inventions disclosed in the claims could cover other embodiments.

The claimed technical solution in its different embodiments could be embodied as computer systems and methods implemented by different computational means, as well as a computer-read data medium storing CPU-run instructions.

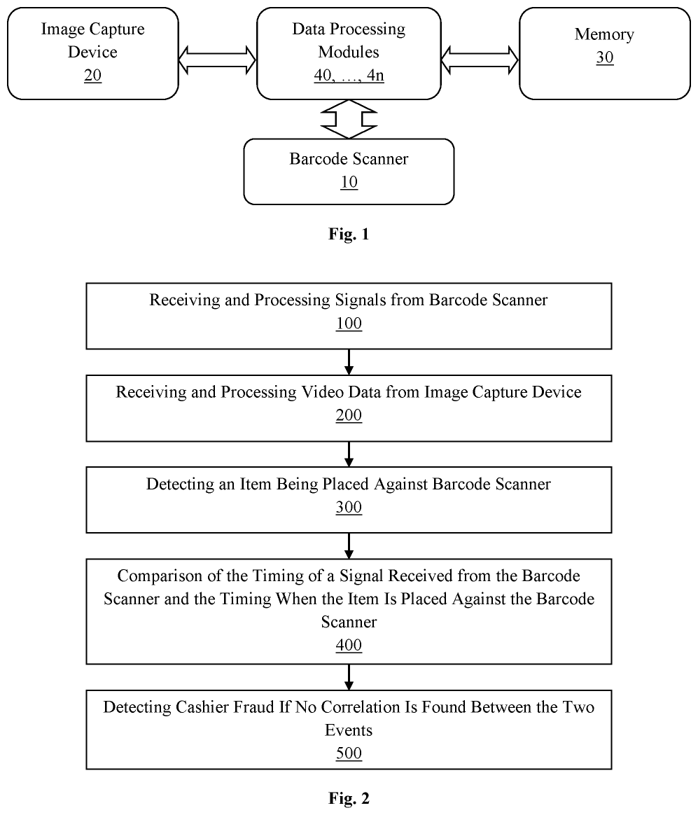

FIG. 1 is a diagram of a computer system detecting cashier fraud. The computer system includes a barcode scanner (10), an image capture device (20), memory (30), and at least one data processing module (40, . . . , 4n).

In this context, computer systems may be computational systems based on hardware and software.

A barcode scanner can be a scanner of any known manufacturer (of any public type, for example, LED scanner, laser scanner, image scanner). A barcode is graphic information printed on the surface or the package of an item with the possibility to reading it with technical devices, for example, a scanner. A barcode could be a QR-code which is recently quite popular in trade.

In the context of this application, an image capture device means a video camera.

A data processing module could be a CPU, microprocessor, ECM (electronic computing machine), PLC (programmable logic controller), or an integrated circuit configured to execute particular data processing commands (instructions, applications).

A memory device configured to store data could be, but not limited to, a hard-drive disk (HDD), flash-drive, ROM (read-only memory), solid-state drive (SSD), etc.

It should be noted that the specified computer system could include any other compatible devices, for example, sensors, input-output devices, display devices, etc.

An example of how the abovementioned computer system works to detect cashier fraud is described below. All further stages of system work could also be applied to the claimed method of detecting cashier fraud.

Let us look at the operating principle in a real time mode. Let us suppose that a customer with an item comes to the cashier at the checkout and would like to buy the product.

An image capture device, a video camera in our case, is located to receive the video data from the cashier barcode scanning area. It should be noted that the computer system could include several extra surveillance cameras to control other zones in checkout area, for example, in the area of receiving the products from the customer and in the pick-up zone for the paid merchandise.

A data processing module is configured to continuously receive and analyze the video data from the image capture device, as well as to receive and to analyze the signals from a barcode scanner.

When a cashier holds an item against the barcode scanner, the data processing module identifies the event of placing the product to this barcode scanner by processing video data. For example, to do this, the video frame has a defined zone, so once an item appears in this zone, the data processing module generates the event of placing the product against the barcode scanner. This zone is set by a computer system operator, for example, to account for barcode recognition distance between the product and the barcode scanner.

Then the data processing module compares the detected event of placing the product against the barcode scanner and the event of receiving the signal from the barcode scanner by a time parameter. If a match is found in the timing of event signals, then the product registration is considered to be successful and error-free. If no match is found between the specified events, then the data processing module detects cashier fraud.

The described computer system aimed to detect cashier fraud is more accurate in comparison with the known solutions due to the recognition of the event of placing the product against the barcode scanner rather than the recognition of the movements in the checkout zone. The advantage of this solution is a decrease in the number of false responses and a better accuracy in detecting the facts of cashier fraud.

The computer system described above is typically used in real-time mode, although it could also be applied to process stored video data from the image capture device and from the barcode scanner. In this alternative, the data from the barcode scanner and the image capture device are automatically stored in the computer system memory. Thus, a security service employee having access to the data can look through it and run analysis and comparison algorithms for the obtained data at any time. For example, to save the resources of the data processing module, a security service employee could run a check once a day or once a week. This inspection takes less time and is more efficient in rare cases of fraud. The results of the inspection can be prepared as a report on a display module or stored in the computer system memory or in the security system database.

Additionally, this computer system is configured so that once cashier fraud is detected, a notification is sent to a defined user of the computer system, for example, to a security service employee. The notification to the user could be an SMS or MMS or an email with a report about the analysis attached. This configuration helps the users promptly respond to the detection of a fraud, as well as to arrest and to make the wrongdoers responsible.

An example of a particular embodiment of a detection method for cashier fraud is described below. FIG. 2 shows a flow-chart of an embodiment method for detecting cashier fraud.

This method is implemented by a computer system with at least one data processing module. The method has the stages where:

(100) the signals from the barcode scanner are received and processed;

(200) video data from the image capture device configured to receive the video data from the cashier barcode scanning area are received and processed;

(300) during the video data processing, at least one data processing module detects at least one event of placing an item against the barcode scanner and

(400) compares the event of receiving the signal from the barcode scanner and the detected events of placing the product against the barcode scanner by a time parameter;

(500) if no match between the specified events is found, then at least one data processing device detects cashier fraud.

These methods can be embodied by a computer system, thus it can be expanded and enhanced using the embodiments which have already been described above to apply the computer system to detect cashier fraud.

The embodiments of the present group of inventions may be implemented by software, hardware, programmable logic devices, or their combination. In the example embodiments, the programmable logic devices, software, or a set of instructions are stored on one or more different traditional computer-readable data media.

In this description, a computer-readable data medium may be any medium or device which can store, contain, transfer, distribute, or transport instructions (commands) for their use (execution) by a computation device, for example, a computer, wherein the data medium could be a transitory or non-transitory computer-read data medium.

At least some of different operations described in this solution may be performed in a different order and/or in parallel.

Although this technical solution has been described in detail to illustrate the most relevant and preferable embodiments, this invention is not limited to the disclosed embodiments, and it is designed for further modification and various combinations of features different from the described embodiments. For example, the present invention permits that one or more features of any embodiments could be combined, if possible, with other one or more features of other embodiments.

1. A fraud detection system comprising:
a barcode scanner;
a video capture device configured to receive video data from a barcode scanning area;
a data processing module configured to receive a scanner signal from the barcode scanner and to process the video data and the scanner signals,
wherein the processing comprises:
determining from the video data a placement time of an item being placed against the barcode scanner; and
detecting fraud using comparison between the placement time and a time of receiving the scanner signal.

2. The system of claim 1, wherein the video data and the scanner signal are processed in real time.

3. The system of claim 1, further comprising a memory module configured to store the video data;
wherein the processing further comprises retrieving the video data from the memory module.

4. The system of claim 1, wherein the processing further comprises sending a fraud notification to a user.

5. The system of claim 1, wherein the barcode scanner is a QR-code compatible scanner.

6. A method of fraud detection comprising:
receiving a scanning signal from a barcode scanner;
capturing video data from a barcode scanning area;
determining from the video data a placement time of an item being placed against the barcode scanner; and
detecting fraud using comparison between the placement time and a time of receiving the scanning signal.

7. The method of claim 6, wherein the video data and the scanning signal are processed in real time.

8. The method of claim 6, further comprising:
storing the video data in a memory module; and
retrieving the video data from the memory module for the determining of the placement time.

9. The method of claim 6, further comprises sending a fraud notification to a user.

10. The method of claim 6, wherein the barcode scanner is a QR-code compatible scanner.

11. Non-transitory computer readable medium storing instructions that, when executed by a computer, cause it to perform the method of claims 6.
